(19) United States
(12) Patent Application Publication
(10) Pub. No.: US 2017/0052326 A1
(43) Pub. Date: Feb. 23, 2017

(54) EXPANDED BEAM CONNECTOR WITH DISCRETE ALIGNMENT ASSEMBLY

(71) Applicant: TYCO ELECTRONICS CORPORATION, BERWYN, PA (US)

(72) Inventors: SOREN GRINDERSLEV, HUMMELSTOWN, PA (US); MICHAEL AARON KADAR-KALLEN, HARRISBURG, PA (US)

(21) Appl. No.: 14/832,741

(22) Filed: Aug. 21, 2015

(51) Int. Cl. G02B 6/38

(52) U.S. Cl. CPC G02B 6/3853; G02B 6/3846; G02B 6/3877

(57) ABSTRACT

An alignment assembly for disposition in an insert for an expanded beam connector, said alignment assembly comprising: (a) at least one cylindrical sleeve having an inner first diameter, and an outer diameter configured to be received in said insert of said connector; (b) a lens disposed in said sleeve, and having a round periphery with a second diameter larger than said first diameter; and (c) a ferrule stub disposed at least partially in said sleeve, and having a round periphery with a third diameter essentially the same as the second diameter, said ferrule stub comprising a fiber stub optically coupled to said lens.

### FIELD OF DISCLOSURE

The present invention relates generally to an optical connector, and, more specifically, to an expanded beam optical connector.

### BACKGROUND

Optical fiber connectors are a critical part of essentially all optical fiber communication systems. For instance, such connectors are used to join segments of fiber into longer lengths, to connect fiber to active devices, such as radiation sources, detectors and repeaters, and to connect fiber to passive devices, such as switches, multiplexers, and attenuators. The principal function of an optical fiber connector is to hold the fiber end such that the fiber's core is axially aligned with an optical pathway of the mating structure. This way, light from the fiber is optically coupled to the optical pathway.

Of particular interest herein are “expanded beam” optical connectors. Such connectors are used traditionally in high vibration and/or dirty environments, where “physical contact” between the fiber and the light path of mating connector is problematic. Specifically, in dirty environments, particulates may become trapped between connectors during mating. Such debris has a profoundly detrimental effect on the optical transmission since the particles are relatively large compared to the optical path (e.g., 10 microns diameter in single mode) and are therefore likely to block at least a portion of the optical transmission. Furthermore, in high-vibration environments, optical connectors having ferrules in physical contact tend to experience scratching at their interface. This scratching diminishes the finish of the fiber end face, thereby increasing reflective loss and scattering.

To avoid problems of debris and vibration, a connector has been developed which expands the optical beam and transmits it over an air gap between the connectors. By expanding the beam, its relative size increases with respect to the debris, making it less susceptible to interference. Further, transmitting the beam over an air gap eliminates component-to-component wear, thereby increasing the connector's endurance to vibration. Over the years, the expanded beam connector has evolved into a ruggedized multi-fiber connector comprising an outer housing which is configured to mate with the outer housing of a mating connector, typically through a screw connection. Contained within the outer housing are a number of inner assemblies or “inserts.” Each insert comprises an insert housing, a cable assembly contained within the insert housing and adapted to receive a fiber, and a ball lens at a mating end of the insert housing optically connected to the fiber. The ball lens serves to expand and collimate light at the connector interface. When two expanded beam connectors are mated, there is an air gap between the ball lenses of each pair of optically coupled inserts.

Tyco Electronics Corporation (Harrisburg, Pa.) currently offers a line of expanded beam connectors under the brand name PRO BEAM®. This connector and improvements thereto are described in U.S. Pat. No. 7,722,261, hereby incorporated by reference. The current design uses a 3.0 mm ball lens mounted on the front end of the insert cavity and affixed with epoxy. A cable assembly, produced separately, is mounted into the insert with a cable assembly mounted on the connector-end of the assembly. For the single mode design, the ferrule brings the fiber endface in contact with the ball lens in order to achieve a high return loss.

Although the multimode (MM) and single mode (SM) expanded beam connectors offered by Tyco Electronics Corporation have consistently met industry requirements, applicants have identified a need for improved manufacturability. For example, the insert is machined with a radiused, annular ridge to seat the ball lens. This radiused seat must be machined with close tolerance (e.g. 2 μm) relative to the position of the ferrule tip. Not only is machining such a curved seat challenging, but also verifying its tolerance compliance is error prone. Thus, the existing verification process tends to be unreliable such that the tolerance compliance of the assembly is not known with any real certainty until the final optical measurement is performed on the product. Determining noncompliance at this stage of manufacture is inefficient and wasteful.

Additionally, during insertion of the cable assembly into the cavity, often the ferrule scrapes along the sidewall of the insert's borehole, creating shavings or debris. This debris may settle on the ferrule end face in a way that can degrade the signal and the return loss.

Therefore, there is a need to improve the manufacturability of the conventional expanded beam product. The present invention fulfills this need among others.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides an “alignment assembly,” which is discrete from the insert. The alignment assembly facilitates the critical alignment of the lens and fiber, both axially and radially, independent of the insert. In other words, the insert is not machined to hold and position the lens or ferrule. Rather, the alignment is achieved in the discrete alignment assembly using a simple cylindrical sleeve. The sleeve is configured to receive a ferrule stub and a lens, which have essentially the same diameter. The sleeve has an internal diameter close to that of the two optical components, but slightly undersized, thus creating a centering clamping force. When the two optical components are mounted inside the split sleeve, the expansion due to the slight size difference causes the centering force to be applied to the optical components, causing them to align relative to each other.

The alignment assembly provides for a number of advantages. For example, by performing the alignment of the lens and fiber externally—independent of the insert—the need to machine the insert to exacting tolerances is alleviated, resulting in easier machining of insert with sufficient metrology. Furthermore, because the alignment of the optical components is performed in the simple, discrete sleeve, which is easily handled and inspected, it is simple to verify the alignment optically before the alignment assembly is mounted into the insert cavity. Thus, aligning the components in the discrete alignment assembly provides a higher acceptance rate of connectors with less scrap. Likewise, because the need to insert a cable assembly in a tightly tolerance borehole in the insert is eliminated, the debris contamination of the conventional connector is also eliminated.

Additionally, the small, easily-handled ferrule stub provides for a number of advantages. Some of the advantages arise from the ability of the ferrule stub to be manufactured and treated in bulk. For example, multiple stubs can be polished simultaneously to provide the desired endface characteristics including, or example, flat, angled and domed endfaces. Additionally, the stubs can be coated with an antireflective (A/R) coating in bulk. While it may be cumbersome to A/R coat the ferrule end face of a cable assembly due to its lack of maneuverability, a large batches of short, easily-handled ferrule stubs can be A/R coated together, thus realizing economies of scale and lower cost. As discussed below, A/R coating allows for less expensive components to be used and enables the same connector configured to be used for SM and MM applications over a wide range of operating wavelengths.

Accordingly, one aspect of the invention is a discrete alignment assembly for insertion into an insert of an expanded beam connector. In one embodiment, the alignment assembly comprises: (a) at least one cylindrical sleeve having an inner first diameter, and an outer diameter configured to be received in the insert of the connector; (b) a lens disposed in the sleeve, and having a round periphery with a second diameter larger than the first diameter; and (c) a ferrule stub disposed at least partially in the sleeve, and having a round periphery with a third diameter essentially the same as the second diameter, the ferrule stub comprising a fiber stub optically coupled to the ball lens.

Another aspect of the invention is an expanded beam connector having a discrete alignment assembly. In one embodiment, the connector comprises: (a) an insert for insertion into an outer housing, the insert having at least one bore hole for receiving an alignment subassembly; (b) an alignment subassembly comprising at least: (i) at least one cylindrical sleeve having an inner first diameter, and an outer diameter configured to be received in the borehole of the insert; (ii) a lens disposed in the sleeve, and having a round periphery with a second diameter larger than the first diameter; and (iii) a ferrule stub disposed at least partially in the sleeve, and having a round periphery with a third diameter essentially the same as the second diameter, the ferrule stub comprising a fiber stub optically coupled to the ball lens.

Yet another aspect of the invention is a method of assembling the expanded beam connector having a discrete alignment subassembly. In one embodiment, the method comprises: (a) preparing an alignment assembly outside of an insert by (i) inserting a lens in a sleeve, the sleeve being cylindrical having an inner first diameter, and an outer diameter configured to be received in a borehole of an insert, the lens and having a round periphery with a second diameter larger than the first diameter such that the sleeve expands to receive the lens; and (ii) inserting a ferrule stub at least partially in the sleeve, the sleeve having a round periphery with a third diameter essentially the same as the second diameter such that the sleeve expands to receive the ferrule stub, the ferrule stub comprising a fiber stub, the ferrule stub being positioned in the sleeve such that the fiber stub optically couples with the lens; (b) inserting the alignment assembly in the inset; and (c) inserting a ferrule of a cable assembly in the alignment assembly.

### BRIEF DESCRIPTION OF DRAWINGS

FIGS. 1(A) and (B) show one embodiment of the alignment assembly of the present invention with a ball lens and with a cylindrical lens, respectively.

FIGS. 2(A) and 2(B) show an alternative embodiment of the alignment assembly of the present invention with a spacer or stop between the lens and the ferrule stub.

FIG. 3 shows the alignment assembly of FIG. 2B with a second split sleeve disposed around the ferrule stub.

FIG. 4 shows the alignment assembly of FIG. 3 disposed in an insert.

FIG. 5 shows the alignment assembly of FIG. 3 disposed in an insert and optically coupled with a cable assembly

FIGS. 6(A)-(C) shows schematics of a split alignment sleeve receiving a ball lens.

FIGS. 7(A)-(C) illustrate different alignment approaches.

### DETAILED DESCRIPTION

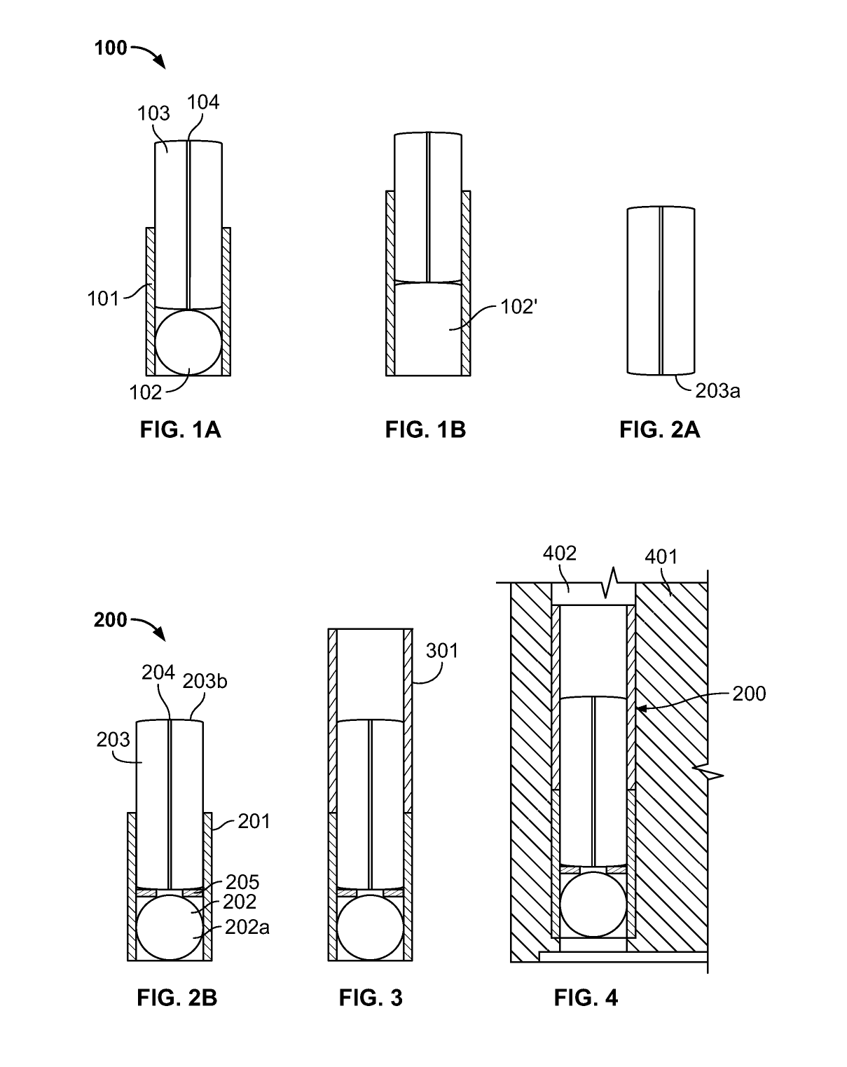

Referring to FIGS. 1 and 2, one embodiment is shown of an alignment assembly 100, 200 for insertion into an insert of an expanded beam connector. As used herein the term “connector” refers to any device used to join a segment of the conductor to (1) another conductor segment, (2) an active device such as a photonic radiation source, detector, or repeater, and (3) a passive device, such as switch, multiplexer, or attenuator. A typical optical fiber connector comprises a housing and a cable assembly within the housing. The cable assembly comprises a ferrule, which has one or more bore holes to accommodate fibers, and a fiber secured in each bore hole such that the end of the fiber is presented for optical coupling by the ferrule. The housing is designed to engage a “mating structure” having an optical path to which the fiber optically couples during mating. The mating structure may be another connector or an active or passive device as mentioned above. The optical path may be, for example, a fiber in a ferrule, a waveguide in a substrate, a lens, or an optically-transparent mass. The principal function of an optical fiber connector is to hold the fiber end such that the fiber's core is axially aligned with optical pathway of the mating structure. This way, light from the fiber is optically coupled to the optical pathway.

For illustrative purposes, the alignment assembly is described in connection with an insert for a ruggedized connector as described above, although it should be understood that the invention is not limited to this embodiment (unless otherwise indicated), and may be embodied alternatively in a discrete connector (i.e., a single ferrule connector) or be integral to an optical device such as a transceiver.

FIGS. 1(A) and (B) show alternative embodiments of the alignment assembly 100 for disposition in an insert (see FIG. 4) for an expanded beam connector. The alignment assembly comprises: (a) at least one cylindrical sleeve 101 having an inner first diameter, and an outer diameter configured to be received in the insert 401 (see FIG. 4) of the connector; (b) a lens 102, 102′ disposed in the sleeve 101, and having a round periphery with a second diameter larger than the first diameter; and (c) a ferrule stub 103 disposed at least partially in the sleeve, and having a round periphery with a third diameter essentially the same as the second diameter, the ferrule stub comprising a fiber stub 104 optically coupled to the ball lens. The lens 102 is a ball lens, while lens 102′ is a cylindrical lens.

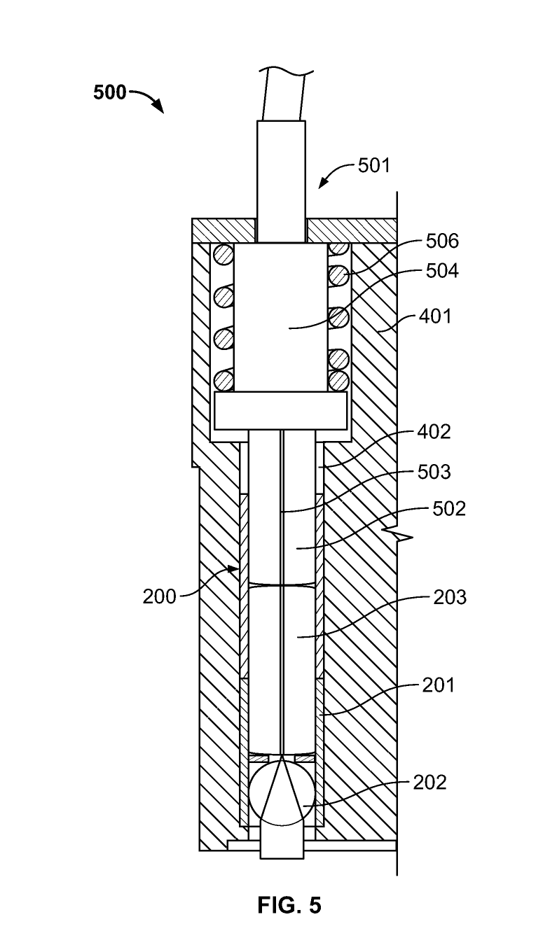

Referring to FIG. 5, an embodiment of the expanded beam connector 500 of the present invention is shown. The expanded beam connector 500 comprises: an insert 401 for insertion into an outer housing (not shown), the insert having at least one bore hole 402 for receiving an alignment assembly; (b) the alignment assembly 200 comprising at least: (i) at least one cylindrical sleeve 201 having an inner first diameter, and an outer diameter configured to be received in the borehole 402 of the insert 401; (ii) a lens 202 disposed in the sleeve, and having a round periphery with a second diameter larger than the first diameter; and (iii) a ferrule stub 203 disposed at least partially in the sleeve 201, and having a round periphery with a third diameter essentially the same as the second diameter, the ferrule stub comprising a fiber stub optically coupled to the ball lens; and (c) a cable assembly comprising at least a ferrule 502 having a borehole and at least one fiber 503 disposed in the borehole such that an end face of the fiber is disposed at an end face of the ferrule and optically coupled with the fiber stub in the ferrule stub. In one embodiment, the cable assembly also comprises a ferrule holder 506 and a spring 506 to bias the ferrule forward relative to the ferrule holder to urge against the ferrule stub to achieve physical contact.

Each of these components is considered in greater detail below.

The insert 401 functions to hold the alignment assembly 200 in axial and radial relative positions within the outer housing. The configuration of the insert with respect to the outer housing is well known, subject to various standards, and, thus, is not considered in detail herein. In one embodiment, the insert 401 comprises an elongated body having a front and back orientation and defining a borehole 402 running from front to back. The borehole 402 is adapted to receive the alignment assembly 200 from the back end. Since the alignment assembly for the SM and MM have essentially the same physical configuration, in one embodiment, the insert 401 is generic to accept either alignment assembly. In this particular embodiment, the insert 401 is an insert housing suitable for insertion into a larger multiconnector outer housing such as the PRO BEAM® connectors offered by Tyco Electronics Corporation. It is frequently preferred to configure the insert housing to receive a plurality of ferrule assemblies. Thus, since the SM and MM may be the same, it is within the scope of the invention that an insert housing be populated with both SM and MM ferrule assemblies.

The alignment assembly functions to align the key optical components—i.e., the lens and the fiber, in a subassembly that is discrete from the insert, and, thus, alleviates the need for the insert to perform the alignment function, which, as described above, can be problematic. In one embodiment, the alignment assembly comprises at least a sleeve, a lens and a ferrule stub (discussed in detail below).

Affixing the alignment assembly to the insert can be performed using any known technique, including, for example, an interference fit, adhesive bond, and welding. Preferably, the alignment assembly is affixed to the housing through an interference fit. To this end, the insert housing may be heated or the alignment assembly cooled to allow the insert housing to receive the alignment assembly. As the temperature difference between the two decreases, the alignment assembly would be secured in the insert housing by an interference fit. This embodiment allows the assembly to be reheated and the alignment assembly removed and replaced if necessary. In one embodiment, the alignment assembly is actively aligned in the insert and then affixed in the insert with adhesive

Alternatively, the alignment assembly may be held loosely within the insert, with a mechanical stop at the distal (lens) end of the insert, such that the spring pushes the alignment assembly against the mechanical stop. In yet another alternative embodiment, the alignment assembly may be captivated within the insert assembly. Still other embodiments will be known or obvious to one of skill in the art in light of this disclosure.

The sleeve functions to align the lens and the fiber in the ferrule stub, and, in one embodiment, to align the fiber in the ferrule stub with the fiber of the cable assembly. The sleeve has various embodiments, although its mechanism for aligning is generally, but not necessarily, the same. Specifically, the sleeve typically has an internal diameter close to that of the two optical elements but slightly undersized thus creating a centering clamping force. Because the diameters of the sleeve and lens are close in size, their mechanical axes will be aligned by the sleeve's clamping forces. Furthermore, the flexibility of the sleeve allows for acceptance of a lens diameters having a generous amount of tolerance.

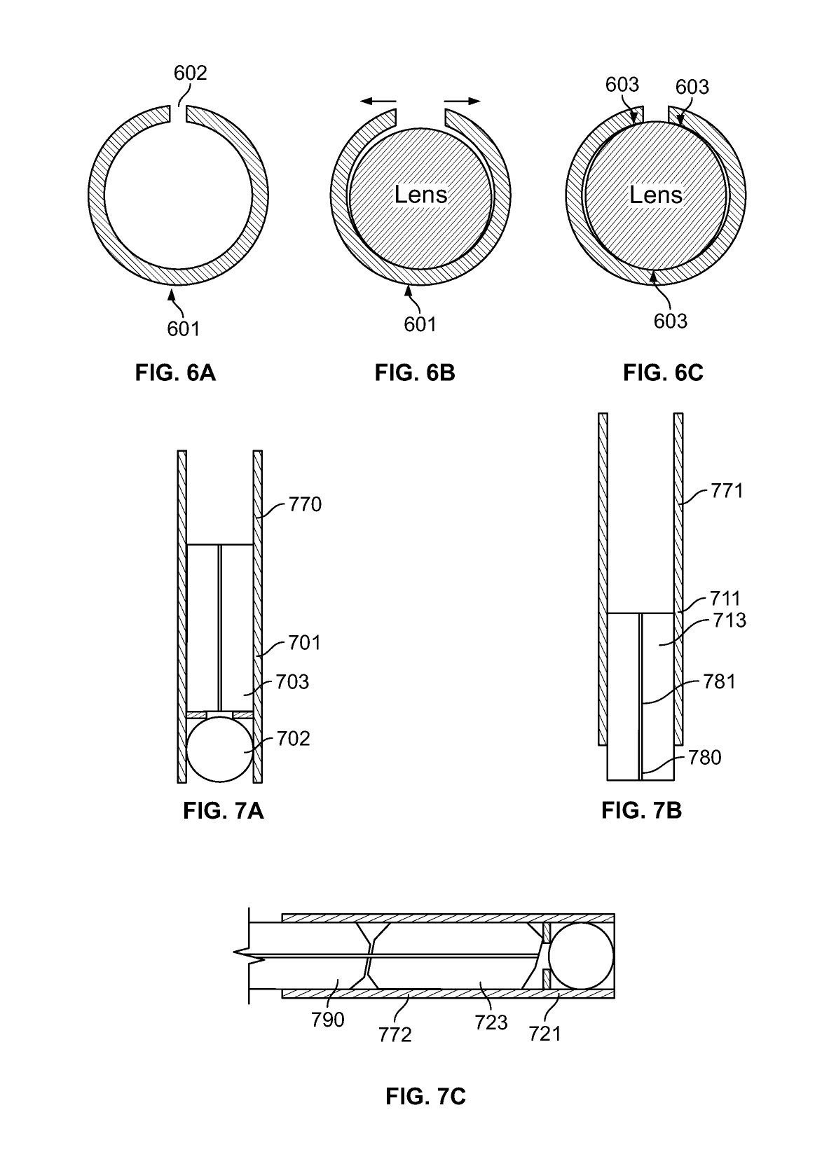

In one embodiment, the sleeve is a compliant sleeve 601 with a slit 602 as shown in FIG. 6A. When the lens is inserted into the sleeve 601, as shown in FIG. 6B, its inner diameter is forced-splayed sufficiently to accept the slightly larger lens diameter. Because the sleeve is now slightly expanded, and (at a micro-level) is not circular anymore, it will exert a 3-point radial clamping force 603 onto the cylindrical lens surface as shown in FIG. 6C. This results in the lens axis and the sleeve axis coinciding. Epoxy may be used to fix the positions permanently.

Other types of sleeves can be used to perform the alignment. For example, it can be a solid tubular sleeve which has a very snug fit relative to the two optical elements. Likewise, although a compliant sleeve is generally preferred, it is not necessary, and the invention may be practiced with rigid sleeves. For example, the alignment can also be achieved by using an interference fit between the components and a tubular sleeve, for example utilizing a press fit insertion process.

It should be understood that other alignment approached may be used. For example, In the embodiment of FIG. 1(A), a split sleeve works very well, because the optical center of a spherical lens is precisely located at the mechanical center of the sphere. Likewise, in FIG. 1 (B), if the lens is a graded index cylindrical lens, then the optical axis is fairly well aligned to the mechanical axis of the cylinder, which tends to be adequate for multimode applications. However, if the lens in FIG. 1 (B) is a refractive lens with a cylindrical body, then it is likely that the optical axis of the lens surface is not accurately aligned to the mechanical axis of the cylinder. In this case, it is necessary to actively align the axes of the ferrule and the cylindrical lens (GRIN or refractive lens, or a GRIN lens with curved surfaces) to achieve low loss. In this case, the assembly can be made using a solid sleeve (cylindrical shell) rather than a split sleeve. The ferrule and cylindrical lens axes are aligned within this sleeve, and then the components are affixed to the sleeve.

In one embodiment, once the assembly 200 is complete, a second sleeve 301 is mounted to the free end or back end 203b of the ferrule stub 203 as shown in FIG. 3. Alternatively, it can be retained by adhesive. In another embodiment, rather than having a discrete second sleeve, the sleeve 201 can be longer such that it extends beyond the free end 203b of the ferrule stub 203 to define a cavity for receiving the ferrule 502 of the cable assembly 501. For example, referring to FIG. 7(A) an embodiment is shown having a single split sleeve 701 for holding the lens 702 and ferrule stub 703, which has an extended portion 770 for receiving a ferrule (not shown). Likewise, FIG. 7(B) shows a split sleeve 711 for holding a ferrule stub 713, which has extended portion 771 for receiving a ferrule (not shown). In the embodiment of FIG. 7(B), the lens is a graded index fiber which is disposed in the ferrule stub and optically coupled with a single mode fiber 781. It should be understood that the use of a graded index fiber (lens) in the ferrule stub is an alternative configuration for all the connector embodiments disclosed herein. Referring to FIG. 7(C), a single split sleeve 721 having an extended portion 772 is shown for an angled-polished ferrule stub 723 optically coupled to an angled-polished ferrule 790.

The lens 102 functions, in one respect, to expand and collimate a relatively narrow optical beam emitted from a fiber into a relatively large beam for transmission through an air gap and into the light path of a mating structure, and, in another respect, to focus a relatively large collimated beam from the mating structuring into the fiber. Suitable lenses include any optical component which is capable of expanding/focusing a light beam and having a circular periphery to be received in the cylindrical sleeve. Suitable lens include, for example, any combination of a ball or cylindrical lens, a molded and/or machined lens, a GRIN lens or fiber, or a lens or lens assembly containing spherical or aspherical surfaces with uniform or graded index lenses. A spherical ball lens is generally preferred, although not necessary, due to excellent alignment existing between its optical and mechanical axes.

In one embodiment, as shown in FIGS. 1 (A) and (B), the lens is a glass material which has a refractive index of 2.0. Such a lens will have its focal point on its surface. Thus, a fiber making contact with the lens will exhibit a high return loss, which is desired in particular for single mode applications.

In an alternative embodiment, the lens has a refractive index below 2 which may be preferable from an economic and availability standpoint. Lens materials having a refractive index (n) less than 2.0 are more common and less expensive. Among major manufacturers of these glasses or similar are Schott, Ohara and others. For example, the following lens materials are suitable for the present invention

| Lens material | BK7 | SF-8 | Sapphire | LaSFN9 | PBH71 |
|---|---|---|---|---|---|
| n(1310) | 1.504 | 1.662 | 1.750 | 1.817 | 1.874 |

Although glass type lenses with an index less than 2.0 tend to be more available and less expensive, such lenses will have a focal point away from the lens surface. For example Schott glass LASF-35 has an index slightly lower than 2.0. This deviation from the desired index of 2.0 causes the focal point to be displaced from the lens surface by approximately 16 microns and with the fiber in contact with the lens and therefore offset from the focal point, a loss of approximately 0.3 dB is added to the TE product. Therefore, the fiber endface must be spaced from the surface of the lens, thereby creating an air gap.

The air gap created between the fiber (now positioned at the focal point) and the lens will add insertion loss to the system due to the index difference between the un-coated fiber and the air. Accordingly, in one embodiment, the lens is a ball lens 202 coated with an antireflective (AR) material 202a for an air/glass interface. For an air-to-glass interface, an ideal coating will have an index of sqrt(n) where n is the index of refraction of the lens material relative to air. The coating thickness is λ/(4n) where λ is the wavelength in air. The coating may be applied only at the region that the light path passes through the lens, or it may be applied uniformly around the ball lens 202 for simplicity and ease of manufacture (i.e., no need to align the lens in the housing).

In one embodiment, the same ball lens is used for both single mode and multimode connectors. This reduces inventory requirements and, thus, costs. The lens may be secured to the housing in this respect using adhesive or any other known technique for securing a lens to a housing.

The ferrule stub 103, 203 functions to hold the fiber stub 104,204 in precise position relative to the lens 102 both radially and axially. In a preferred embodiment, the ferrule stub comprises an elongated ferrule 103 having a front and back orientation with a bore hole that runs from front to back. The fiber 104 is disposed in the bore hole such that it presents an end face at the front and back ends 203a, 203b of the ferrule stub. The fiber stub may be any known fiber for transmitting optical signals including, for example, single mode, multimode, or polarization maintaining, or multi-core fiber.

In one embodiment, the alignment assembly is configured with a stop 205 to receive and position a ferrule relative to the lens. For example, referring to FIG. 5, in this embodiment, the ferrule stub 203 is eliminated, and the ferrule 502 is configured to contact the spacer/stop 205 to position the ferrule end face in the alignment assembly relative to the lens 202.

In one embodiment, an antireflective (AR) coating is applied to the front face of the ferrule stub to minimize back reflection at the ferrule/lens interface. Such AR coatings are well known in optics. For example, using an AR coating reduces the Fresnel loss at the air/glass interface from 0.16 dB to less than 0.01 dB. Thus, the loss of a MM mated pair is reduced by 0.3 dB compared to prior art connectors described above. Further, the return loss from the glass/air interface can be made greater than 36 dB. As a result, the MM design can also be used for SM connectors, resulting in a lower-cost, lower-loss, more reliable design that reduces the number of insert parts that must be stocked

The ferrule stub facilitates tuning and manufacturability of the connector. For example, in one embodiment, if modal noise is introduced due to the increased number of interfaces for the single mode connector, it can be minimized by using a special fiber for the fiber stub termination which has a reduced cutoff wavelength, so that higher-order modes are attenuated more rapidly through the ferrule stub. In one embodiment, the fiber stub has a lower cutoff wavelength than that of the fiber in the cable assembly.

In one embodiment, the fiber in the ferrule stub is a premium fiber having a tighter tolerance on the outer diameter and on the core-cladding concentricity offset than standard fiber. Because only a small length of fiber is used, the additional cost of this fiber used within an alignment assembly is negligible.

The ferrule stub also facilitates manufacturability by facilitating the treatment of ferrule stubs in bulk given their small size and ease of handling. For example, while the lack of maneuverability of cable assembly makes AR-coating their endfaces difficult to do in large quantities, A/R coating short ferrule stubs can be done in large quantities. Thus, A/R coating becomes a practical way to reduce the insertion loss and reduces component costs as discussed above. Furthermore, the simple nature of the device also allows the vendor to test the antireflective coating prior to its installation in the insert housing. Additionally, the small and maneuverable fiber stubs facilitate bulk polishing. In one embodiment, the ferrule stub is pre-polished before insertion into the alignment assembly. Both the manufacturability and the ease of inspection simplify the connector, lower cost, and improve reliability.

Although the ferrule stub is depicted herein as having only one fiber, it should be understood that other embodiments are possible, including multiple fiber stubs in a single ferrule stub.

In one embodiment, the ferrule stubs are commercially-available components, which typically come in diameters of 1.25 mm and 2.50 mm. Although the ferrule diameter itself has no influence on optical performance, generally (but not necessarily) there is a preference to use a ferrule and lens of the same size or as close as practical based on the commercial availability of the components. For example, one configuration uses a standard 2.5 mm ferrule and a standard 3 mm lens (mating a 2.5 mm lens to a 3.0 mm lens adds less than 0.15 dB for single mode fiber at a wavelength of 1310 nm).

The spacer 205 (or stop 205) functions to space the lens from the fiber endface such that the fiber endface is positioned at the focal point of the lens to create an air gap therebetween. The air gap has a number of advantages. For example, such a configuration (along with A/R coating) facilitates the use of a more economical ball lens since it is well known that lenses having a focal point on the surface of the lens tend to be more difficult to produce thus more expensive. In such an embodiment, the use of a spacer between the ferrule and the ball lens provides for the precise spacing between the end face of the ferrule and the ball lens such as the end face of the ferrule which is essentially at the focal point of the lens. In one embodiment, the spacer 205 is integral with the sleeve and thus functions also as a stop to position the lens and ferrule or ferrule stub.

Furthermore, the air gap provides for a connector design in which components can be shared between single mode and multimode connectors. Specifically, the configuration of FIG. 2(B) eliminates the physical contact between the cable assembly and the lens in the single mode connector, thereby rendering it similar to the multimode connector design. This configuration avoids the need to provide a lens AR coated one side for a glass/glass interface and the other side for an air/glass interface (as with the embodiments of FIGS. 1(A) and (B)). Rather, a lens AR coated for only an air/glass interface can be used for both connector types. Indeed, in a preferred embodiment, the same lens is used for both single and multimode connectors. Thus, the design of the present invention not only reduces the cost of the lens for the single mode connector, but also reduces inventory costs since only one lens is used for both the single mode and multimode connectors in a preferred embodiment.

Providing an air gap at the interface of the ferrule stub and the lens also allows for the independent movement of the ferrule stub with respect to the lens without damage to the components. In other words, since the components are not in contact, their vibration or other movement will not cause them to wear against each other. Additionally, since they are not in contact, the ferrule stub may be rotated with respect to the lens for tuning purposes. This is not a viable option if the ferrule stub contacts the ball lens in which case such rotation would scratch the components at their interface.

Another advantage of the air gap is that debris does not get wedged between the lens and the ferrule as in the prior art. In the new design, such debris is not a problem because there is no physical contact.

Yet another advantage is the ability to adjust the air gap with the spacer to facilitate tuning of the connector for different wavelengths. Specifically, the alignment assembly of the present invention also can be adjusted to accommodate different wavelength signals by adjusting the air gap or A/R thickness. Specifically, in one embodiment, the thickness of the spacer is altered to change the distance from the second surface of the spacer to the ball lens. By way of background, it is well known that different wavelength signals result in different focal points. To couple the light effectively between the fiber and the lens, the focal point should be coincident with the surface of the fiber. Thus, for optimum coupling efficiency, the air gap should be adjustable for different wavelength signals.

Although various methods can be derived for performing these basic steps, the following procedure has been found to produce satisfactory results. Referring to FIGS. 2-5, in one embodiment, the assembly process comprises: (a) preparing an alignment assembly 100, 200 outside of an insert by (i) inserting a lens in a sleeve, said sleeve being cylindrical having an inner first diameter, and an outer diameter configured to be received in a borehole of an insert, said lens and having a round periphery with a second diameter larger than said first diameter such that said sleeve expands to receive said lens; and (ii) inserting a ferrule stub at least partially in said sleeve, said sleeve having a round periphery with a third diameter essentially the same as the second diameter such that said sleeve expands to receive said ferrule stub, said ferrule stub comprising a fiber stub, said ferrule stub being disposed in said sleeve such that the fiber stub optically couples with said lens; after step (a), (b) inserting said alignment assembly in said insert; and (c) inserting a ferrule of a cable assembly in said alignment assembly such that a fiber in said ferrule is optically coupled to said fiber stub. In one embodiment, step (a) also includes disposing a second sleeve on said ferrule stub as shown in FIG. 3, such that said second sleeve extends beyond said ferrule stub to define a cavity for receiving said ferrule of said cable assembly. In one embodiment, step (b) involves actively aligning the alignment assembly in the insert prior to affixing the assembly to the insert.

What is claimed is:

1. An alignment assembly for disposition in an insert for an expanded beam connector, said alignment assembly comprising:
at least one cylindrical sleeve having an inner first diameter, and an outer diameter configured to be received in said insert of said connector,
a lens disposed in said sleeve, and having a round periphery with a second diameter larger than said first diameter; and
a ferrule stub disposed at least partially in said sleeve, and having a round periphery with a third diameter essentially the same as the second diameter, said ferrule stub comprising a fiber stub optically coupled to said lens.

2. The alignment assembly of claim 1, wherein said sleeve is a split sleeve.

3. The alignment assembly of claim 1, wherein said sleeve contacts each of said lens and said fiber sub along three different radial points.

4. The alignment assembly of claim 1, wherein said sleeve is an elastomeric sleeve.

5. The alignment assembly of claim 1, wherein said lens is a ball lens.

6. The alignment assembly of claim 1, wherein said lens is cylindrical lens.

7. The alignment assembly of claim 6, wherein said lens is a graded index fiber stub.

8. The alignment assembly of claim 1, wherein said lens contacts said ferrule stub.

9. The alignment assembly of claim 1, wherein said lens is spaced from said ferrule stub to define an air gap therebetween.

10. The alignment assembly of claim 9, further comprising a spacer between said ferrule stub and said lens.

11. The alignment assembly of claim 9, wherein said fiber and said lens are A/R coated for an air/glass interface.

12. The alignment assembly of claim 1, further comprising: a second sleeve enveloping a portion of said ferrule stub and defining a cavity for receiving a ferrule of a cable assembly.

13. The alignment assembly of claim 1, wherein said sleeve is compliant.

14. The alignment assembly of claim 1, wherein said fiber stub has a cutoff wavelength lower than the cutoff wavelength of a fiber in a cable assembly optically coupled to said ferrule stub.

15. An expanded beam connector comprising:
an insert for insertion into an outer housing, said insert having at least one bore hole for receiving an alignment subassembly;
an alignment subassembly comprising at least:
at least one cylindrical sleeve having an inner first diameter, and an outer diameter configured to be received in said borehole of said insert;
a lens disposed in said sleeve, and having a round periphery with a second diameter larger than said first diameter; and
a ferrule stub disposed at least partially in said sleeve, and having a round periphery with a third diameter essentially the same as the second diameter, said ferrule stub comprising a fiber stub optically coupled to said lens.

16. The connector of claim 15, further comprising a spacer between said ferrule and said lens.

17. The connector of claim 16, wherein said fiber and said lens are A/R coated for an air/glass interface.

18. The connector of claim 15, further comprising a second sleeve enveloping a portion of said ferrule stub and defining a cavity for receiving a ferrule of cable assembly.

19. The connector of claim 15, further comprising a cable assembly comprising at least a ferrule having a borehole and at least one fiber disposed in said borehole such that an end face of the fiber is disposed at an end face of said ferrule and optically coupled to said fiber stub.

20. The connector of claim 19, wherein said cable assembly further comprises a ferrule holder and a spring to bias said ferrule forward relative to said ferrule holder to urge against said ferrule stub to achieve physical contact.

21. The connector of claim 19, wherein said fiber stub has a cutoff wavelength lower than the cutoff wavelength of said fiber in said cable assembly.

22. The connector of claim 15, wherein said sleeve is compliant.

23. A method assembling an expanded beam connector
preparing an alignment assembly outside of an insert by
inserting a lens in a sleeve, said sleeve being cylindrical having an inner first diameter, and an outer diameter configured to be received in a borehole of an insert, said lens and having a round periphery with a second diameter larger than said first diameter such that said sleeve expands to receive said lens; and
inserting a ferrule stub at least partially in said sleeve, said sleeve having a round periphery with a third diameter essentially the same as the second diameter such that said sleeve expands to receive said ferrule stub, said ferrule stub comprising a fiber stub, said ferrule stub being positioned in said sleeve such that said fiber stub optically couples with said lens;
inserting said alignment assembly in said insert; and
inserting a ferrule of a cable assembly in said alignment assembly.

24. The method of claim 23, wherein preparing said alignment assembly further comprises disposing a second sleeve on said ferrule stub such that said second sleeve extends beyond said ferrule stub to define a cavity for receiving said ferrule of said cable assembly.
